(19) United States
(12) Patent Application Publication
(10) Pub. No.: US 2012/0094224 A1
(43) Pub. Date: Apr. 19, 2012

(54) ENCAPSULATED DYES FOR NON-WATER BASED PRINTING APPLICATIONS

(76) Inventors: Sivapackia Ganapathiappan, Los Altos, CA (US); Doris Pik-Yiu Chun, Santa Clata, CA (US); Hou Ng, Campbell, CA (US)

(21) Appl. No.: 12/903,899

(22) Filed: Oct. 13, 2010

(51) Int. Cl. G03G 9/09; C08L 33/08; C08L 33/12

(52) U.S. Cl. 430/105; 524/560; 524/556

(57) ABSTRACT

Encapsulated dyes for non-water based printing applications comprise a plurality of dye molecules embedded in a polymeric matrix. A process for making the encapsulated dyes and an electrophotographic ink including an ink vehicle and the encapsulated dyes are also provided.

### BACKGROUND ART

Digital printing involves technologies in which a printed image is created directly from digital data, for example using electronic layout and/or desktop publishing programs. Known methods of digital printing include full-color ink-jet, electrophotographic printing, laser photo printing, and thermal transfer printing methods.

Electrophotographic printing techniques involve the formation of a latent image on a photoconductor surface mounted on an imaging plate. The photo-conductor is first sensitized to light, usually by charging with a corona discharge, and then exposed to light projected through a positive film of the document to be reproduced, resulting in dissipation of the charge in the areas exposed to light. The latent image is subsequently developed into a full image by the attraction of oppositely charged toner particles to the charge remaining on the unexposed areas. The developed image is transferred from the photoconductor to a rubber offset blanket, from which it is transferred to a substrate, such as paper, plastic or other suitable material, by heat or pressure or a combination of both to produce the printed final image.

The latent image is developed using either a dry toner (a colorant mixed with a powder carrier) or a liquid ink (a suspension of a colorant in a liquid carrier). The toner or ink generally adheres to the substrate surface with little penetration into the substrate. The quality of the final image is largely related to the size of the particles, with higher resolution provided by smaller particles.

Dry toners used in solid electrophotography are fine powders with a relatively narrow particle size distribution that are expelled from fine apertures in an application device. A typical dry toner is predominantly composed of a heat-sensitive polymer (e.g., acrylic, styrene) and a pigment such as carbon black with a solid carrier, typically resin coated iron or steel powders. Variations in particle shape and charge-to-mass ratio as well as dust particles found in the dry ink may cause technical difficulties during the printing process. Larger or irregularly shaped particles can cause blockage while dust particles that are too small to hold a sufficient charge to be controllable adhere to the print head surface.

Liquid inks used in liquid electrophotography are generally comprised of pigment- or dye-based thermoplastic resin particles suspended in a non-conducting liquid carrier, generally a saturated hydrocarbon. Offset-preventing and release-facilitating oil, such as silicone oil, is often used to increase the efficiency of ink transfer from the imaging surface. The liquid ink is electrophotographically charged and brought into contact with the photoconductor surface to develop the latent image. When transferred to an offset blanket and heated, the particles melt and fuse to form a tacky polymer film. When the tacky polymer film comes in contact with a cooler surface, such as a paper substrate, the film hardens and adheres to the substrate and peels away from the blanket, laminating the paper. The ink is deposited onto the substrate essentially dry, and desired print finishing can be performed immediately. Since the ink is transferred essentially completely from the blanket to the substrate, a new layer in a different color can be created for every rotation of the press.

### BRIEF DESCRIPTION OF THE DRAWINGS

FIG. 1 is a schematic representation of an encapsulated dye particle, in accordance with examples of the invention.

FIG. 2 is a flow chart depicting an example for preparing the encapsulated dye particles.

FIG. 3 is a flow chart depicting another example for preparing the encapsulated dye molecules.

### BEST MODES FOR CARRYING OUT THE INVENTION

Reference is made now in detail to specific examples, which illustrates the best mode presently contemplated by the inventors for practicing the invention. Alternative examples are also briefly described as applicable.

Before the present invention is disclosed and described, it is to be understood that this disclosure is not limited to the particular process steps and materials disclosed herein because such process steps and materials may vary somewhat. It is also to be understood that the terminology used herein is used for the purpose of describing particular examples only. The terms are not intended to be limiting because the scope of the present disclosure is intended to be limited only by the appended claims and equivalents thereof.

It is noted that, as used in this specification and the appended claims, the singular forms “a,” “an,” and “the” include plural referents unless the context clearly dictates otherwise.

As used herein, “electrophotographic ink vehicle” refers to a solvent containing a polymer-encapsulated dye that has been formulated for electrophotographic printing.

As used herein, “solvent” refers to the fluid in which the polymerencapsulated dye of the present disclosure can be dispersed to form a dispersion of the polymer-encapsulated dye. Such a solvent can be formulated into an electrophotographic ink vehicle appropriate for electrophotographic printing where the electrophotographic ink vehicle has a viscosity and conductivity for such printing and may include a mixture of a variety of different agents, including without limitation, surfactants, organic solvents and co-solvents, charge control agents, buffers, biocides, viscosity modifiers, sequestering agents, stabilizing agents, and anti-kogation agents. Though not part of the electrophotographic ink vehicle per se, in addition to the polymer-encapsulated dye, the liquid vehicle can include a dispersant for the polymer-encapsulated dye and can further carry solid additives such as polymers, latexes, UV curable materials, plasticizers, salts, charge control agents etc.

As used herein, “co-solvent” refers to any solvent, including organic solvents, present in the electrophotographic ink vehicle.

As used herein, “dye” generally refers to the individual compound, complex, or molecule responsible for an ink's color, and is typically water-insoluble. Such dyes, however, may or may not be soluble in non-polar carriers, such as Isopar™.

As used herein, T_{g} is the glass transition temperature as calculated by the Fox equation: copolymer T_{g}=1/(Wa/(T_{g}A)+Wb(T_{g}B)+ . . . ), where Wa=weight fraction of monomer A in the copolymer and T_{g}A is the homopolymer T_{g} value of monomer A, Wb =weight fraction of monomer B and T_{g}B is the homopolymer T_{g} value of monomer B, etc.

As used herein, “surface roughness” refers to a measure of the roughness of a surface as determined by the difference in height between the highest peak on the surface and the lowest valley on the surface.

As used herein, “substituted” means that a hydrogen atom of a compound or moiety is replaced by another atom such as a carbon atom or a heteroatom, which is part of a group referred to as a substituent. Substituents include, for example, alkyl, alkoxy, aryl, aryloxy, alkenyl, alkenoxy, alkynyl, alkynoxy, thioalkyl, thioalkenyl, thioalkynyl, thioaryl, etc.

As used herein, “heteroatom” refers to nitrogen, oxygen, halogens, phosphorus, or sulfur.

As used herein, “alkyl” refers to a branched, unbranched, or cyclic saturated hydrocarbon group, which typically, although not necessarily, contains from 1 to about 50 carbon atoms, or 1 to about 40 carbon atoms, or 1 to about 30 carbon atoms, for example. Alkyls include, but are not limited to, methyl, ethyl, n-propyl, isopropyl, n-butyl, isobutyl, t-butyl, octyl, and decyl, for example, as well as cycloalkyl groups such as cyclopentyl, and cyclohexyl, for example. The term “lower alkyl” refers to an alkyl group having from 1 to 6 carbon atoms. The term “higher alkyl” refers to an alkyl group having more than 6 carbon atoms, for example, 7 to about 50 carbon atoms, or 7 to about 40 carbon atoms, or 7 to about 30 carbon atoms or more. As used herein, “substituted alkyl” refers to an alkyl substituted with one or more substituent groups. The term “heteroalkyl” refers to an alkyl in which at least one carbon atom is replaced with a heteroatom. If not otherwise indicated, the term “alkyl” includes unsubstituted alkyl, substituted alkyl, lower alkyl, and heteroalkyl.

As used herein, “aryl” refers to a group containing a single aromatic ring or multiple aromatic rings that are fused together, directly linked, or indirectly linked (such that the different aromatic rings are bound to a common group such as a methylene or ethylene moiety). Aryl groups described herein may contain, but are not limited to, from 5 to about 50 carbon atoms, or 5 to about 40 carbon atoms, or 5 to 30 carbon atoms or more. Aryl groups include, for example, phenyl, naphthyl, anthryl, phenanthryl, biphenyl, diphenylether, diphenylamine, and benzophenone. The term “substituted aryl” refers to an aryl group comprising one or more substituent groups. The term “heteroaryl” refers to an aryl group in which at least one carbon atom is replaced with a heteroatom. If not otherwise indicated, the term “aryl” includes unsubstituted aryl, substituted aryl, and heteroaryl.

As used herein, the term “about” is used to provide flexibility to a numerical range endpoint by providing that a given value may be “a little above” or “a little below” the endpoint. The degree of flexibility of this term can be dictated by the particular variable and would be within the knowledge of those skilled in the art to determine based on experience and the associated description herein.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary.

Concentrations, amounts, and other numerical data may be expressed or presented herein in a range format. It is to be understood that such a range format is used merely for convenience and brevity and thus should be interpreted flexibly to include not only the numerical values explicitly recited as the limits of the range, but also to include all the individual numerical values or subranges encompassed within that range as if each numerical value and subrange is explicitly recited. As an illustration, a numerical range of “about 1 wt % to about 5 wt %” should be interpreted to include not only the explicitly recited values of about 1 w t% to about 5 wt %, but also include individual values and sub-ranges within the indicated range. Thus, included in this numerical range are individual values such as 2, 3.5, and 4 and sub-ranges such as from 1 to 3, from 2 to 4, and from 3 to 5, etc. This same principle applies to ranges reciting only one numerical value. Furthermore, such an interpretation should apply regardless of the breadth of the range or the characteristics being described.

Turning now to a discussion of the examples of the present invention, the encapsulation of dyes is disclosed for use in non-water based carriers and in environmentally friendly solvent carriers. These encapsulated particles will find applications in liquid electrophotography, dry electrophotography, inkjet printing, and inkjet hybrid transfer printing process. This encapsulation leads to better print quality because the colorants (dyes) are more finely distributed throughout the polymer matrix compared to an encapsulated pigment particle system. Generally, pigment particles have particle sizes in the range of hundreds of nanometers, whereas dyes, being molecular, are a few nanometers in size.

The dyes are encapsulated in a polymer matrix. Consequently, the color gamut is increased because there is an increased molecular distribution of dyes in the polymer matrix over dyes not so encapsulated in the polymer matrix. That is to say, the colorant is confined in a specific location (i.e., in the encapsulated polymer particle), whereas it is diffused over a larger area if present in the soluble form; particle diffusion is much slower in the print media than the dye itself. These dye-encapsulated particles exhibit better durability and light-fastness than the dye itself because of the association with polymers. Together, the improved performance is attractive using the low-cost dyes for printing applications.

The formation of particles that can charge and discharge uniformly is disclosed herein. The finely distributed dye particles are made to ensure that they are covered with polymer completely. The level of polymer particles found without incorporation of dye molecules is significantly lower than the case where solid pigments are involved. This resolves an issue in the regular pigment encapsulation. Excess dye molecules (not incorporated in the final particles) can be easily removed by simple post-processing procedures, such as centrifuging with washing steps, and can be recycled for next round of production.

These polymer-encapsulated dye particles can be stabilized better than dye molecules alone in solvents commonly used in liquid electrophotographic process such as Isopar™ paraffinic liquids (available from ExxonMobil Chemical Company, Houston, Tex.). Uniformity of charging the particles is ensured, since the polymer encapsulating the dye molecules is not as susceptible to electric fields as are the dye molecules themselves, due to the presence of functional groups, such as amines and carboxylates on the dye molecules. For example, dyes with groups such as —NH₂ or —COON will have a stronger influence in terms of mobility in the E-field. If the dye is encapsulated, the influence of the functional groups is reduced or even eliminated. Print quality can be significantly improved because of the improvement in the formation of regularly shaped and mostly spherical particles. In addition, the T_{g} of the particles can be controlled to form printed films at a relatively lower temperature and may save significantly on the cost of the prints per page. The pressure and temperature required to fuse the particles to the media may also be lowered considerably while saving time and energy with improved print quality.

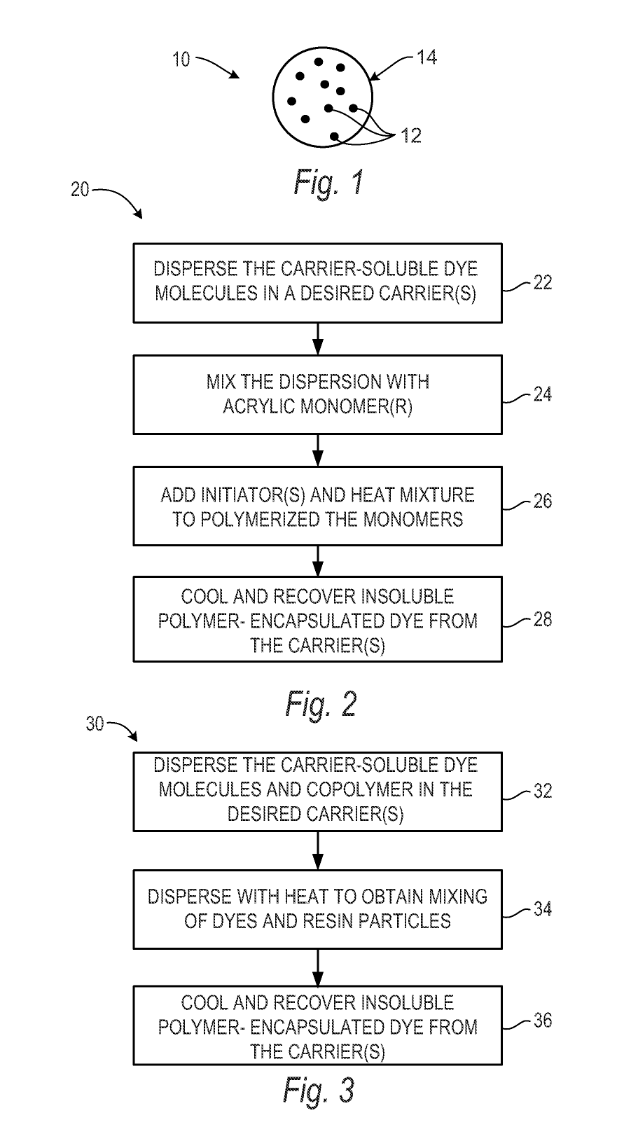

The general structure of the encapsulated dye particle is shown in FIG. 1. As depicted in FIG. 1, the dye particle 10 comprises a plurality of dye molecules 12 encapsulated in a matrix 14 of a polymer. The size of the assembly (dyes plus polymer) may be in the range of about 200 nanometers (nm) to 10 micrometers (μm).

There are two polymer systems that may be considered as representative of the teachings herein. The first polymer system comprises styreneacrylate polymers. The second polymer system comprises a copolymer of ethylene and acrylic acid. The styrene-acrylate polymer system may involve polymerizing a mixture of monomers in the presence of the dye molecules. The ethylene-acrylic acid copolymer may be heated to a temperature sufficient to soften it and encapsulate dye molecules. In either case, the encapsulated dye particles comprise about 1 to 20 weight percent (wt %) dye and the balance polymer. If the concentration of the dye is too low, then the resulting print may be unacceptably light, whereas if the concentration of the dye is too high, the assembly may behave more like a pigment. In an example, the encapsulated dye particles comprise about 20 wt % dye and 80 wt % polymer.

### I. Styrene-Acrylate Polymers

FIG. 2 illustrates an example process 20 for incorporating dye molecules 12 into a matrix 14 of styrene-acrylate based polymers. The carrier-soluble dye molecules may be dispersed 22 in the desired carriers such as Isopar™ or other environmentally friendly solvents. In some examples, the dye is dispersed in the same liquid used to prepare the ink, e.g., Isopar™. It is easier to disperse dyes, which are molecular, in solvent than to disperse conventional regular pigments, which are much larger particles.

Next, the dispersion may be mixed 24 with acrylic monomers of a desired composition having a pre-determined T_{g} for easy film formation. Generally, in some examples, the T_{g} may be in the range of 35° to 125° C. In other examples, the T_{g} may be in the range of 50° to 75° C.

Next, at least one initiator may be added and the mixture may be heated 26 to an elevated temperature to polymerize the monomers. Examples of initiators that may be used include, but are not limited to, diazo radical initiators, such as azobisisobutyronitrile (AIBN), and peroxides, such as benzoyl peroxide. The concentration of the initiator(s) is in the range of 0.001 to 0.05 wt % of the total composition (carrier, dye, and monomer(s)).

The temperature of heating may be in the range of 80° to 180° C. In some examples, the temperature of heating may be in the range of 120° to 180° C.

One or more stabilizers may be added so that the dispersion polymerization will more easily result in spherical particles and more control over the particle size. The stabilizers increase the life/stability of the growing chains; some examples of stabilizers include, but are not limited to, polyvinylpyrrolidone, methocel, and ethocel.

During the polymerization, the molecular weight of the polymer may increase as the polymerization proceeds. At some point, the polymerization may reach a stage in which the polymer becomes insoluble in that solvent. At this time, the polymer encapsulates the dye that is molecularly dispersed in that solvent. The insoluble polymer may be recovered 28 from the solvent. For example, recovery may be made just by removing the supernatant by decantation, since the particles settle down within few hours; for some cases, if they do not settle because of smaller size, then mild centrifugation can be used. Alternatively, the carrier (solvent) plus polymer mixture may be used to form the ink.

Color dyes which constitute the CMYK (cyan-magenta-yellow-black) gamut may be employed in this method. Examples of dyes that may be employed include, but are not limited to, Solvent Red 24, Solvent Red 26, Solvent Red 164, Solvent Yellow 124, Solvent Blue 35, Acid Black 1, Acid Brilliant Yellow 2G 150%, Acid Metanil Yellow MT 100%, Acid Golden Yellow G 120%, Acid Brilliant Yellow G 100%, Acid Brilliant Red 10B 140%, Acid Navy Blue GR 140%, Acid Black M-B, Acid Black N-T, Disperse Blue 56, Disperse Blue L-2BLN 150%, Disperse Yellow M-5R 200%, Disperse Yellow M-FL 100%, Disperse Yellow L-2G 200%, Disperse Yellow M-3G 100% and Rhodamine oleate.

The durability properties such as lightfastness, waterfastness, and smearfastness is expected to increase, since the dye particles 12 have become an integral part of the polymer matrix 14. This approach is considered to be a unique method for encapsulating dyes.

Several additives required for the electrophotographic process may be added at the beginning of the above-described process or they may be added during the process or at the end of process by simple milling to make the distribution more uniform. Examples of such additives include, but are not limited to, commercially-available charge control agents, such as PRO-TONER™ CCA 7 (available from Fuji Film) and aluminum stearate.

Examples of monomers for the styrene-acrylate polymer system include, but are not limited to, methyl methacrylate, ethyl methacrylate, propyl methacrylate, butyl methacrylate, hexyl methacrylate, lauryl methacrylate, octadecyl acrylate, and styrene. In the above examples, methacrylates can be changed to acrylates also. Mixture of these monomers can be used to adjust the T_{g} of the polymers and effective means of coating. Some acid-containing monomers, such as acrylic, methacrylic, itaconic, maleic and vinyl benzoic acids may be used to improve the charging and discharging process and stability of these suspensions in solvent.

The dye molecules may be dispersed in solvents such as ethyl acetate. Ethyl acetate is a slightly polar solvent and serves to facilitate the dye to become more soluble or dispersible. Finally, the entire mixture is diluted with Isopar™ so that the polarity of the medium does not increase significantly. In another example, Isopar™ along with a small quantity of aluminum stearate may be employed.

The dispersion may be achieved by a conventional milling process. The milling media may be glass or zirconia beads and milled using a paint shaker, attritor or jar mill. It will be understood that in some examples, the monomer may be soluble in the solvent (carrier), while the polymer is insoluble in the same solvent (carrier).

The dispersed dye particles may be mixed with acrylic monomers along with the initiators capable of producing radicals. Upon heating (for thermal initiators) or exposing to UV light (for photo initiators), polymerization of monomers takes place. Examples of thermal initiators are listed above; examples of photo initiators include, but are not limited to, ethyl diphenyl phosphinite, 4-methylbenzophenone, 4-phenylbenzophenone, benzildimethylketal, ethyl-4-dimethylaminobenzoate and 2-hydroxy-2-methyl-phenyl-propan-1-one.

As the polymerization proceeds, the growing polymer chain solubility decreases with an increase in the molecular weight. As it reaches a certain molecular weight, the growing polymer becomes insoluble in the solvent and precipitate out of the solution. At this time, the insoluble polymer coats the dyes present in the system. If the polymer is still soluble, it can be made insoluble by adding non-solvents to aid in the recovery of the polymer-encapsulated dyes.

### II. Copolymer of Ethylene and Acrylic Acid

FIG. 3 illustrates an example process 30 for incorporating dye molecules 12 into a matrix 14 of a copolymer of ethylene and acrylic acid. The carriersoluble dye molecules may be dispersed 32 in the desired carriers such as Isopar™, together with desired ratios of the polymeric resin particles. The concentration of the dye plus copolymer may be up to 30 wt % in the carrier.

The dispersion may then be heated 34 to an elevated temperature to obtain mixing of the dye molecules and resin particles. In an example, the temperature may be raised to between 120° and 180° C. Heating may be done for about 0.5 to 8 hours, depending on the rate of reaction. In some examples, heating may be done for 3 to 6 hours.

Upon cooling, composite colored resin particles may be obtained. Several additives required for the electrophotographic process may be added in the beginning of the process or they can be added during the process or at the end of process by simple milling to make the distribution more uniform.

### III. Inks

An electrophotographic ink may comprise an ink vehicle and any encapsulated dye disclosed herein dispersed in the ink vehicle. In some examples, the ink vehicle may be non-polar aliphatic solvents, such as paraffinic liquids (e.g., Isopar™), mineral spirits, or petroleum distillates or non-polar aromatic solvents, such as toluene or xylene. In such an ink, the concentration of the polymer-encapsulated dye may range from about 0.2 to 5 wt %, the concentration of the solvent/co-solvent may range from about 80 to 98 wt %, and the concentration of other additives (discussed below, may range from about 1 to 15 wt %.

The electrophotographic ink vehicles may include a solvent or multiple co-solvents. In addition to the polymer-encapsulated dye and solvent(s), e.g., aliphatic solvent, the balance of the formulation can include other vehicle components known in the art, such as biocides, viscosity modifiers, materials for pH adjustment, sequestering agents, preservatives, and the like. The jetting architecture that can be used with the inks of the present disclosure includes thermal and piezoelectric print heads for electrophotographic printing applications.

Classes of co-solvents that can be used can include organic co-solvents including aliphatic alcohols, aromatic alcohols, diols, glycol ethers, polyglycol ethers, caprolactams, formamides, acetamides, and long chain alcohols. Examples of such compounds include primary aliphatic alcohols, secondary aliphatic alcohols, 1,2-alcohols, 1,3-alcohols, 1,5-alcohols, ethylene glycol alkyl ethers, propylene glycol alkyl ethers, higher homologs (C₆-C₁₂) of polyethylene glycol alkyl ethers, N-alkyl caprolactams, unsubstituted caprolactams, both substituted and unsubstituted formamides, both substituted and unsubstituted acetamides, and the like.

Consistent with the formulation of this disclosure, various other additives may be employed to optimize the properties of the ink composition for specific applications. Sequestering agents, such as EDTA (ethylene diamine tetra acetic acid), may be included to eliminate the deleterious effects of heavy metal impurities, and buffer solutions may be used to control the pH of the ink. From 0 wt % to 2 wt %, for example, can be used. Viscosity modifiers and buffers may also be present, as well as other additives known to those skilled in the art to modify properties of the ink as desired. Such additives can be present at from 0 wt % to 20 wt %.

The electrophotographic ink vehicle may also include a surfactant. In one example, the surfactant may be stearic acid, dioctylsulfosuccinate, dioctylbezenesulfonic acid and sodium dodecylsulfate. In another example, the surfactant may be a nonionic surfactant. Suitable surfactants that can be used include alkyl polyethylene oxides, alkyl phenyl polyethylene oxides, polyethylene oxide block copolymers, acetylenic polyethylene oxides, polyethylene oxide (di)esters, polyethylene oxide amines, protonated polyethylene oxide amines, protonated polyethylene oxide amides, dimethicone copolyols, substituted amine oxides, and the like. The amount of surfactant added to the electrophotographic inks may range from 0.01 wt % to 10 wt %.

The electrophotographic ink compositions of the present disclosure can also be suitable for use on many types of substrates of recording media, including but not limited to vinyl media, cellulose-based paper media, various cloth materials, polymeric materials (non-limitative examples of which include polyester white film or polyester transparent film), photopaper (non-limiting examples of which include polyethylene or polypropylene extruded on one or both sides of paper), metals, and/or mixtures or composites thereof. A non-limiting example of a suitable metal material is a metal in foil form made from, for example, at least one of aluminum, silver, tin, copper, ceramics, alloys thereof, and/or mixtures thereof. In one example, the recording medium can include paper or specially coated media.

In one example, Rhodamine oleate (1 g) is mixed with methyl methacrylate (3.5 g) and butyl acrylate (0.5 g). Next, polyvinylpyrrolidone of molecular weight 10,000 (0.1 g) and azobisisobutyronitrile (20 mg) are added to the above mixture. The mixture is diluted with Isopar™ L (20 g). This mixture is heated to 90° C. for 3 h while stirring moderately to obtain encapsulated particles.

In another example, Rhodamine oleate (1 g) is mixed with Isopar™ L (20 g) and heated to 125° C. Next, poly(ethylene-co-acrylic acid) (3 g) is added to make a homogeneous solution. The resultant mixture is cooled to ambient temperature to obtain dye encapsulated particles in Isopar™ L.

Advantageously, low-cost dyes may be used as colorants compared to pigment particles. Dyes are molecularly dispersed in the polymer matrix and more loading of dyes is possible than can be achieved by dyes alone in the ink vehicle. In addition, more statistically uniform loading of dyes is achievable. Even though dyes are used, the durability of dye encapsulated particles may be higher because of the presence of the polymer matrix to protect the dyes from external environments such as moisture, oxidation, rub, scratch, highlighters and other external forces. The polymer forms final near-spherical particles, which are more manageable than elongated particles in electrophotographic printing. These new polymer-encapsulated dye particles improve charging and discharging characteristics, since the polymer, not dyes with their functional groups, is exposed to the electric field. These particles improve the film formation process (since rheological properties of polymers are not adversely affected by the presence of the regular solid pigment nanoparticles) at lower desired temperature and lower pressure. These particles can be dispersed easily in the carriers or can be used as dry toners along with other additives such as charge directors or flow agents after removing the carriers.

A method of formation of particles that can charge and discharge uniformly is described herein. The finely distributed dye particles are made to ensure that they are covered with polymer substantially completely. The level of polymer particles found without incorporation of dye molecules is significantly lower than the case where solid pigments are involved. Excess dye molecules (not incorporated in the final particles) can be easily removed by simple postprocessing such as centrifuging with washing steps, and can be recycled for the next round of production. These particles can be stabilized better in solvents commonly used in liquid electrophotographic process such as Isopar™. In addition, the T_{g} of the particles can be controlled to form print film at a relatively lower temperature and may save significantly on the cost of the prints per page. The pressure (about 1 to 5 psi) and temperature (about 60° to 100° C.) required to fuse the particles to the print media during printing can also be lowered while saving time and energy with improved print quality.

What is claimed is:

1. Encapsulated dyes for non-water based printing applications comprising a plurality of dye molecules embedded in a polymeric matrix.

2. The encapsulated dyes of claim 1 wherein the polymeric matrix comprises either a styrene-acrylate based polymer or a copolymer of ethylene and acrylic acid.

3. The encapsulated dyes of claim 2 wherein the polymeric matrix comprises a styrene-acrylate based polymer and wherein the styrene-acrylate based polymer is derived from a mixture of monomers selected from the group consisting of methyl methacrylate, ethyl methacrylate, propyl methacrylate, butyl methacrylate, hexyl methacrylate, lauryl methacrylate, octadecyl acrylate, methyl acrylate, ethyl acrylate, propyl acrylate, butyl acrylate, hexyl acrylate, lauryl acrylate, and styrene.

4. The encapsulated dyes of clam 3 wherein the mixture of monomers further includes acid-containing monomers selected from the group consisting of acrylic, methacrylic, itaconic, maleic, and vinyl benzoic acids.

5. The encapsulated dyes of claim 1 wherein the concentration of dye in the polymeric matrix ranges from about 1 to 20 wt %.

6. The encapsulated dyes of claim 5 wherein the concentration of dye in the polymeric matrix is about 20 wt %.

7. The encapsulated dyes of claim 1 in which the non-water based printing application employs a non-polar liquid.

8. A process for making encapsulated dyes for printing applications, the encapsulated dyes comprising a plurality of dye molecules in a polymeric matrix, the process comprising either:
dispersing a plurality of dye molecules and a mixture of acrylic monomers in a carrier vehicle to form a dispersion;
adding an initiator and heating the dispersion to an elevated temperature to initiate polymerization of the monomers to encapsulate the dye molecules; and
cooling the encapsulated dye molecules to recover the encapsulated dyes, or
dispersing a plurality of dye molecules and a copolymer of ethylene and acrylic acid in a carrier vehicle to form a dispersion;
heating the dispersion to an elevated temperature to encapsulate the dye molecules; and
cooling the encapsulated dye molecules to recover the encapsulated dyes.

9. The process of claim 8 wherein the polymeric matrix comprises the mixture of acrylic monomers and wherein:
the plurality of dye molecules and the mixture of acrylic monomers are dispersed in a non-polar carrier vehicle to form the dispersion;
the initiator is added to the dispersion, the initiator being selected from the group of thermal initiators and photo initiators, and the dispersion is heated to a temperature within a range of 80° to 180° C.; and
the dispersion is cooled and the encapsulated dye molecules are recovered.

10. The process of claim 9 wherein the acrylic monomers are selected from the group consisting of methyl methacrylate, ethyl methacrylate, propyl methacrylate, butyl methacrylate, hexyl methacrylate, lauryl methacrylate, octadecyl acrylate, methyl acrylate, ethyl acrylate, propyl acrylate, butyl acrylate, hexyl acrylate, lauryl acrylate, and styrene.

11. The process of clam 10 wherein the mixture of acrylic monomers further includes acid-containing monomers selected from the group consisting of acrylic, methacrylic, itaconic, maleic and vinyl benzoic acids.

12. The process of claim 8 wherein the concentration of dye in the polymeric matrix ranges from about 1 to 20 wt %.

13. The process of claim 8 wherein the polymeric matrix comprises the copolymer of ethylene and acrylic acid and wherein:
the plurality of dye molecules and the copolymer of ethylene and acrylic acid are dispersed in a non-polar carrier vehicle to form a dispersion;
the dispersion to an elevated temperature within a range of about 120° to 180° C.; and
the dispersion is cooled and the encapsulated dye molecules are recovered.

14. An electrophotographic ink including an ink vehicle and encapsulated dyes dispersed in the ink vehicle, the encapsulated comprising a plurality of dye molecules embedded in a polymeric matrix, the ink vehicle comprising a nonpolar liquid.

15. The electrophotographic ink of claim 14 wherein the polymeric matrix comprises either a styrene-acrylate based polymer or a copolymer of ethylene and acrylic acid.

16. The electrophotographic ink of claim 15 wherein the polymeric matrix comprises a styrene-acrylate based polymer and wherein the styrene-acrylate based polymer is derived from a mixture of monomers selected from the group consisting of methyl methacrylate, ethyl methacrylate, propyl methacrylate, butyl methacrylate, hexyl methacrylate, lauryl methacrylate, octadecyl acrylate, methyl acrylate, ethyl acrylate, propyl acrylate, butyl acrylate, hexyl acrylate, lauryl acrylate, and styrene.

17. The electrophotographic ink of clam 16 wherein the mixture of monomers further includes acid-containing monomers selected from the group consisting of acrylic, methacrylic, itaconic, maleic, and vinyl benzoic acids.

18. The electrophotographic ink of claim 14 wherein the concentration of dye in the polymeric matrix ranges from about 1 to 20 wt %.

19. The electrophotographic ink of claim 18 wherein the concentration of dye in the polymeric matrix is about 20 wt %.

20. The electrophotographic ink of claim 14 wherein the non-polar liquid is selected from the group consisting of paraffinic liquids, mineral spirits, petroleum distillates, and aromatic solvents.
